(19) United States
(12) Patent Application Publication
(10) Pub. No.: US 2013/0155049 A1
(43) Pub. Date: Jun. 20, 2013

(54) MULTIPLE HARDWARE CURSORS PER CONTROLLER

(71) Applicant: Luugi Marsan, Ontario (CA)

(72) Inventor: Luugi Marsan, Ontario (CA)

(21) Appl. No.: 13/326,817

(22) Filed: Dec. 15, 2011

(51) Int. Cl. G06T 15/00

(52) U.S. Cl. 345/419

(57) ABSTRACT

A system and method for providing a 3D selection technique in a graphics system. A processor receives update information corresponding to multiple views of a cursor on a three-dimensional (3D) display. The graphics processor determines a height and a width for multiple images based on the received information. Each one of the multiple images corresponds to a respective one of the multiple views of the cursor. The graphics processor accesses cursor shape data stored in memory at locations outside of an address space for a frame buffer storing data for a 3D scene being displayed on the 3D display. The graphics processor arranges the shape data in a format for displaying each one of the plurality of images according to the respective height and width. The subsystem includes output buffers that send the multiple images to a display engine with corresponding placement information describing a location on the 3D display.

### FIELD OF THE INVENTION

This invention relates to electronic circuits, and more particularly, to efficiently providing a 3D selection technique in a computing system.

### BACKGROUND

In computing systems, input devices allow a user to provide data and control signals to the system whether it is a desktop, a server, a laptop, portable device, and so forth. Keyboards, mouse devices, touch screens, joysticks, and light pens are some examples of input peripheral devices. In order for a user to interact with software applications executing on a computer, a visual (graphical) display is typically presented to the user. The graphical display may be a computer monitor or a mobile device screen. A selection technique is provided to the user for selecting objects within the graphical display. Typically, the selection technique includes a pointer, such as a “mouse pointer” which is used to specify a position in a space of the graphical display.

In order to relate the positional information of the pointer on the graphical display space to the user, a particular shape may be used to provide visual feedback. This particular shape may be referred to as a “cursor”. Often, an arrow-like shape pointing up and to the left may show the pointer's position. However, the shape may be configurable and changed to other choices of shapes.

The graphical display visually presented to the user is typically a two-dimensional (2D) space. However, modern display devices and techniques are able to create the illusion of visual depth by providing two slightly different images of a same object to the user. The slight differences, which may be referred to as binocular disparity, provide information to the user's brain to process an estimated depth in a visual scene. In general, human eyes are approximately 6.5 centimeters (cm), which is referred to as Inter-Ocular Distance (IOD). Each eye has a slightly different view of a same object. The brain assembles the disparate views of the object in a way that allows us to experience the stereoscopic depth perception providing a three-dimensional (3D) image. Presenting 3D images to the user may be used in may different types of applications, such as medical applications to present models of organs, science applications to present models of chemical compounds, architecture applications to create models of proposed buildings and landscapes, video game applications, and otherwise.

Using a cursor to point to objects for selection purposes becomes more complex for 3D graphical applications. A user expects to freely move the cursor throughout the 3D space and to point to any arbitrary point in the 3D space. To achieve these expectations, two or more different views of a 2D cursor may be provided with a given disparity. Adjusting the amount of the disparity controls the cursor depth within a 3D space projected by a stereoscopic display. In a software cursor implementation, the cursor is redrawn in video memory each time the user moves it to a new location within the 3D space. When the cursor is redrawn, other particular information stored in video memory is refreshed. This particular information is associated with the area of the graphical display that the cursor was covering before the move. As the user moves the cursor throughout the 3D space, the repeated redrawing utilizes a significant amount of processing power, and may adversely affecting performance.

In view of the above, efficient methods and systems for efficiently providing a 3D selection technique in a video graphics subsystem are desired.

### SUMMARY OF EMBODIMENTS

Systems and methods for efficiently providing a 3D selection technique in a computing system are contemplated. In one embodiment, a computing system includes a graphics processor and a memory that stores data for one or more shapes associated with a cursor. The graphics processor receives update information corresponding to multiple views of a cursor on a three-dimensional (3D) display. The update information may be from a software application passing the information through an operating system (OS) and associated application programmer's interfaces (APIs) and drivers.

The graphics processor determines one or more dimensions for multiple images based on the received information. Each one of the multiple images corresponds to a respective one of the multiple views of the cursor. The graphics processor accesses cursor shape data stored in the memory at locations outside of an address space for a frame buffer storing data for a 3D scene being displayed on the 3D display. The graphics processor arranges the shape data in a format for displaying each one of the multiple images according to the respective height and width. The system includes output buffers that send the multiple images to a display engine with corresponding placement information describing a location on the 3D display. The cursor may be managed by the hardware in the computing system separate from the software managing the 3D scene on the same 3D display.

These and other embodiments will be further appreciated upon reference to the following description and drawings.

### BRIEF DESCRIPTION OF THE DRAWINGS

FIG. 1 is a generalized block diagram of one embodiment of a stereo vision system.

FIG. 2 is a generalized block diagram of one embodiment of a three-dimensional (3D) scene.

FIG. 3 is a generalized block diagram of another embodiment of a 3D scene.

FIG. 4 is a generalized block diagram of yet another embodiment of a 3D scene.

FIG. 5 is a generalized block diagram of still another embodiment of a 3D scene.

FIG. 6 is a generalized block diagram of one embodiment of a video graphics subsystem.

FIG. 7 is a generalized block diagram of one embodiment of a hardware cursor view generator.

FIG. 8 is a generalized block diagram of one embodiment of a video graphics driver layering model.

FIG. 9 is a generalized flow diagram of one embodiment of a method for using hardware to update a three-dimensional (3D) cursor in a 3D scene.

FIG. 10 is a generalized block diagram of one embodiment of a computing system.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION OF EMBODIMENTS

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention.

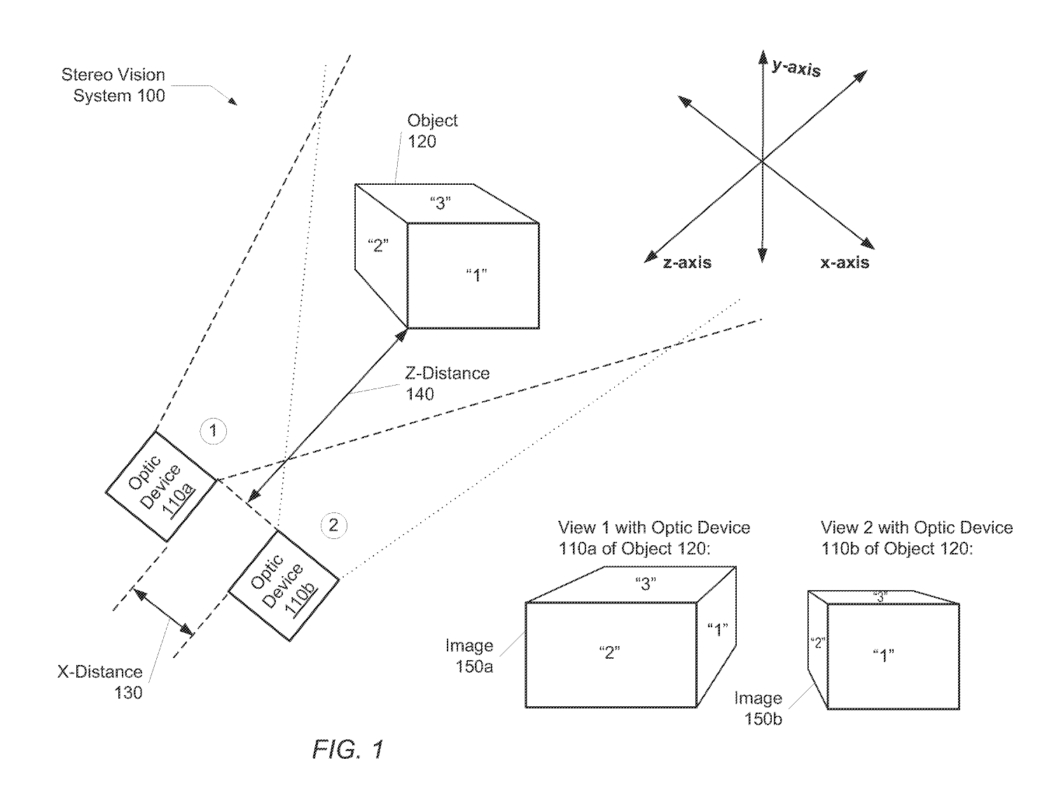

Referring to FIG. 1, a generalized block diagram of one embodiment of a stereo vision system 100 is shown. The object 120 may represent a person, furniture, a tree, a chemical compound, or some other item within a three-dimensional (3D) scene. In one embodiment, a Cartesian coordinate system in three dimensions is selected as shown. An ordered triplet of axes with any two of them being perpendicular may be used to describe the positions of multiple items and points in space within the three-dimensional space in system 100. The coordinate system may utilize any point within the system 100 as a frame of reference.

The object 120 may have an ability to move in both a positive and a negative direction along each of the 3 axes (x-axis, y-axis and z-axis). In addition, the object 120 may rotate about the three perpendicular axes. As the movement along each of the three axes is independent of each other and independent of the rotation about any of these axes, the motion of the object 120 has six degrees of freedom (DOF). In various embodiments, a user may utilize at least the object 120 and its maneuverability within the 3D space described by the 3 axes for applications in video gaming, business, medical, science and engineering, and so forth.

In one embodiment, each of the optic devices 110a-110b is a camera, such as a video camera. In another embodiment, the optic devices 110a-110b make up a pair of eyes of a user observing the object 120 in the 3D scene. In another embodiment, the optic devices 110a-110b are a pair of eyes of a user with a pair of polarized eyeglasses between the eyes and the object 120. When the object 120 is viewed, each of the optic devices 110a-110b receives a dissimilar image of the object 120. The dissimilarities may be small due to a relatively small distance between them denoted as x-distance 130. In one embodiment, the x-axis may be selected to be a horizontal axis parallel with the optic devices 110a-110b. The z-axis may be selected to be on a same two-dimensional plane as the x-axis with the z-axis traversing perpendicular to each of the optic devices 110a-110b. A y-axis may be selected to be a vertical axis perpendicular to the x-axis. Of course, the axes may be otherwise chosen.

The distance between the optic devices 110a-110b may be indicated as x-distance 130. The distance between the optic devices 110a-110b and the object 120 may be indicated as z-distance 140. Additionally, the object 120 may be above or below a line of sight for the optic devices 110a-110b. Accordingly, a nonzero vertical distance along the y-axis may be indicated, although not shown here. Each of the two dissimilar images 150a-150b may indicate the images observed by the optic devices 110a-110b, respectively. The separate and dissimilar images 150a-150b may form a parallax. Generally, a parallax is a displacement or difference in the apparent position of an object viewed along two different lines of sight. The difference may be measured by the angle or semi-angle of inclination between those two lines. The distance between the optic devices 110a-110b may be referred to as the baseline and is shown as the x-distance 130. This distance can affect the disparity of a specific point on a respective image plane. As the x-distance 130 increases, the disparity increases due to the greater angle needed to align the sight on the specific point. In other examples, the disparity may be measured as coordinate differences of the specific point between the right and left images instead of a visual angle. The units may be measured in pixels.

The visual inputs to the optic devices 110a-110b may be processed by a user's brain as a single perception, rather than processed as two distinct images. The user's brain may combine the two images by matching up the similarities and adding in the small differences. The small differences, which may also be referred to as binocular disparity, provide information that the brain can use to calculate depth in the visual scene. This combined image results in a 3D stereo picture. This binocular single vision, or stereopsis, allows the user to distinguish the length, width and height of the object 120 in addition to the depth and the distance between them. Stereopsis is used to describe the user's brain fusing together the two images 150a-150b, rather than processing the images 150a-150b separately. Accordingly, the user is capable of distinguishing between a 2D scene and a 3D scene.

Various methods, such as passive, active shutter and auto-stereoscopic display, may be used to send slightly different perspectives of the same object to each eye. In the above example, only two slightly different images, or perspectives, are used to construct a 3D object. However, typically, multiple perspectives, many more than two, may be used to construct 3D images in a scene. A simplified example includes multiple parallel cameras located on a same baseline at equal distances. All corresponding projections of a 3D point on a display screen may be located at a same raster line with a same disparity. As result, one of the views may be considered as a reference for disparity calculations and the corresponding projection of other views may be determined with respect to the reference view.

As described earlier, the above 3D capability may be used in multiple applications and industries. While observing the 3D sampled models in a 3D scene, users may expect to interact with the objects and the scene. To do so, a cursor associated with an input device may be used. Again, an input device could be a mouse, a keyboard, an air mouse or air joystick, and so forth.

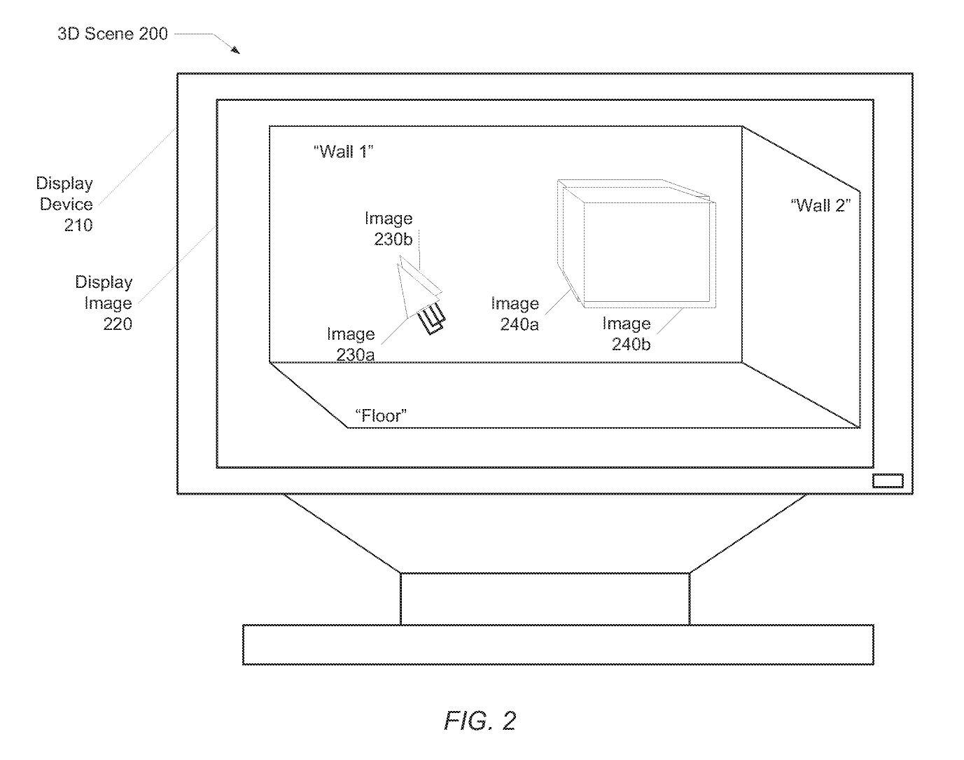

Turning now to FIG. 2, a generalized block diagram illustrating one embodiment of a three-dimensional (3D) scene 200 is shown. The display device 210 may, for example, include a television or computer monitor that include a thin film transistor liquid crystal display (TFT-LCD) panel or any other suitable display technology. Additionally, the display device 210 may include monitors for laptops and other mobile devices. Further, the display device may be a projection screen installed in a home, a conference room or a theater building.

An example of a simplified 3D scene is shown in display image 220. As shown, two walls (“Wall 1” and “Wall 2”) and a floor provide an environment for an object and a cursor. Each of the object and the cursor may have multiple images presented on the display image in order to provide a perception of depth. For example, an object is shown to include an image 240a and a second image 240b. The images 240a-240b may be placed within the display image 220 at particular coordinates that provide binocular disparity. In one embodiment, the coordinates may be referenced at a bottom left corner of each one of the images 240a-240b. Similarly, a cursor may include the images 230a-230b that provide a perception of depth. In one example, the cursor has the familiar arrow-like shape pointing up and to the left. However, other shapes are possible and contemplated.

The user may change a point-of-view (pov) in the display image 220 with an input peripheral device and navigate in and round the presented objects, such as the room with the 3D box made up of images 240a-140b. In addition to moving around the room, the user may maneuver the cursor around the room and around the presented 3D box. The user may use the cursor to point to and select objects.

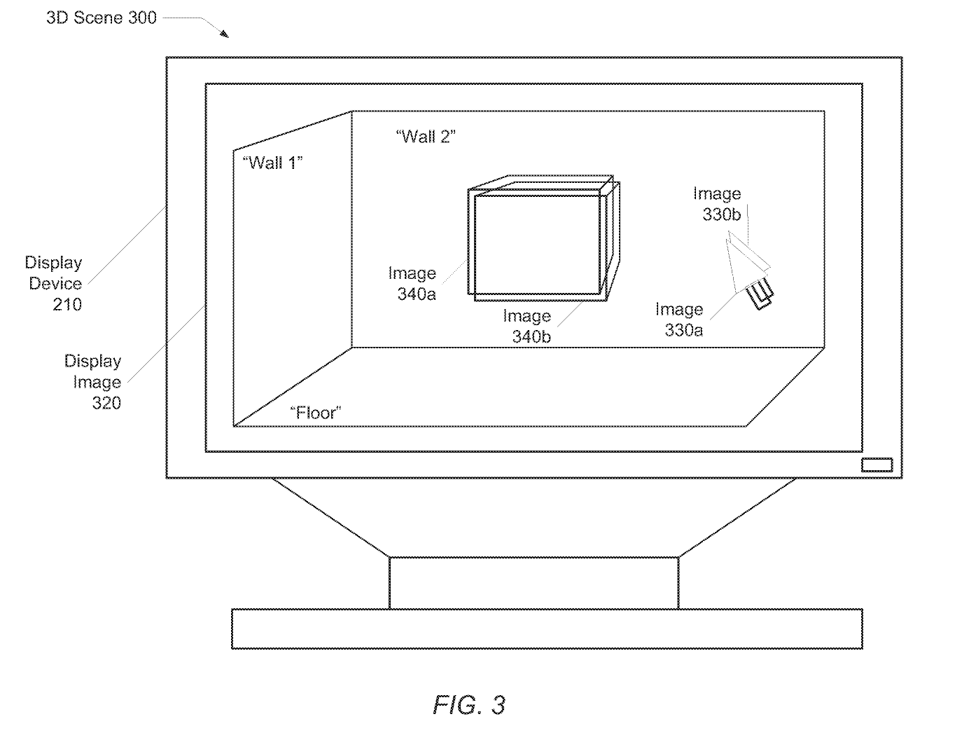

Turning now to FIG. 3, a generalized block diagram illustrating another embodiment of a three-dimensional (3D) scene 300 is shown. The display device 210 may include another simplified 3D scene as shown in display image 320. The 3D scene shown in the display image 320 may include a same room as the room shown in the display image 220, but with a different pov. For example, the user may have changed the pov to face the wall on the right, which was “Wall 2”. Now, “Wall 2” is the front facing wall with the previous front facing wall, which is referred to as “Wall 1”, as a wall located on the left. Different images may be used to present the 3D box and the 3D cursor within the display image 320. For example, the new pov has a different front facing side for the 3D box. The images 340a-340b may be placed within the display image 320 at particular coordinates that provide binocular disparity.

In a similar manner as the placement for the images 340a-340b for the 3D box, the images 330a-330b may be placed at particular coordinates to provide a perception of depth. Here, the 3D cursor is shown as being located to the right of the 3D box, whereas in the previous pov, the 3D cursor was shown as being to the left of the 3D box. Therefore, the 3D cursor may not be located as deep in the 3D scene as the 3D cursor. The 3D box may be located closer to the “Wall 1” than it is to the open wall area on the opposite side of the room.

As shown, the view of the 3D box may change as the user changes the pov used to view the 3D scene. For example, the user may see the different sides and top and bottom of the 3D box as the pov is maneuvered around the 3D scene. In one embodiment, the 3D cursor may have a perception of depth, but the same view of the cursor is shown during each pov. As shown in each of display images 220 and 320, the images 230a-230b and 330a-330b may have different coordinates and different heights and widths, but the same general shape is used. Although the cursor provides a perception of depth within a 3D scene, a top or bottom or other areas of the cursor may not be shown as the pov of changes. In other embodiments, the cursor may show different surface area as the pov changes.

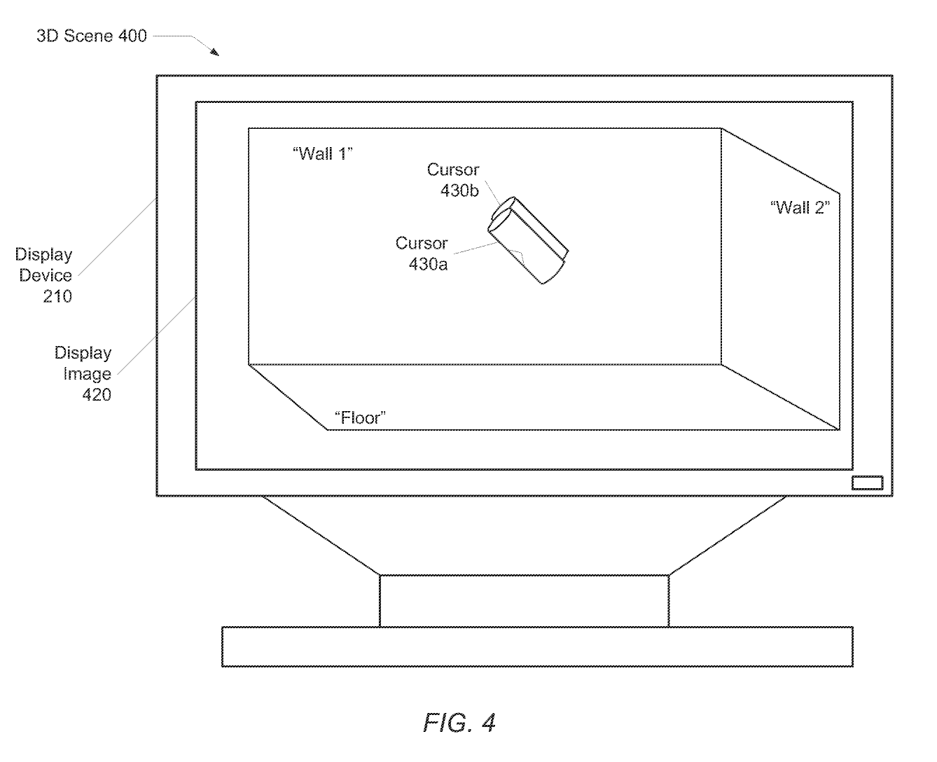

Referring now to FIG. 4, a generalized block diagram illustrating another embodiment of a three-dimensional (3D) scene 400 is shown. The display device 210 may include another simplified 3D scene as shown in display image 420. Here, only a cursor is shown and no other object. The cursor may include images 430a-430b placed at particular coordinates to provide a perception of depth. As shown, this cursor does not have the familiar arrow-like shape pointing up and to the left. Rather, the cursor in the display image 420 has a cylindrical shape with a diamond on the bottom. The pov of the user may be the same as the pov shown for display image 220 in FIG. 2. Here, the back wall is “Wall 1” with “Wall 2” positioned to the right. As the user changes the pov, more surface area of the cursor may be presented.

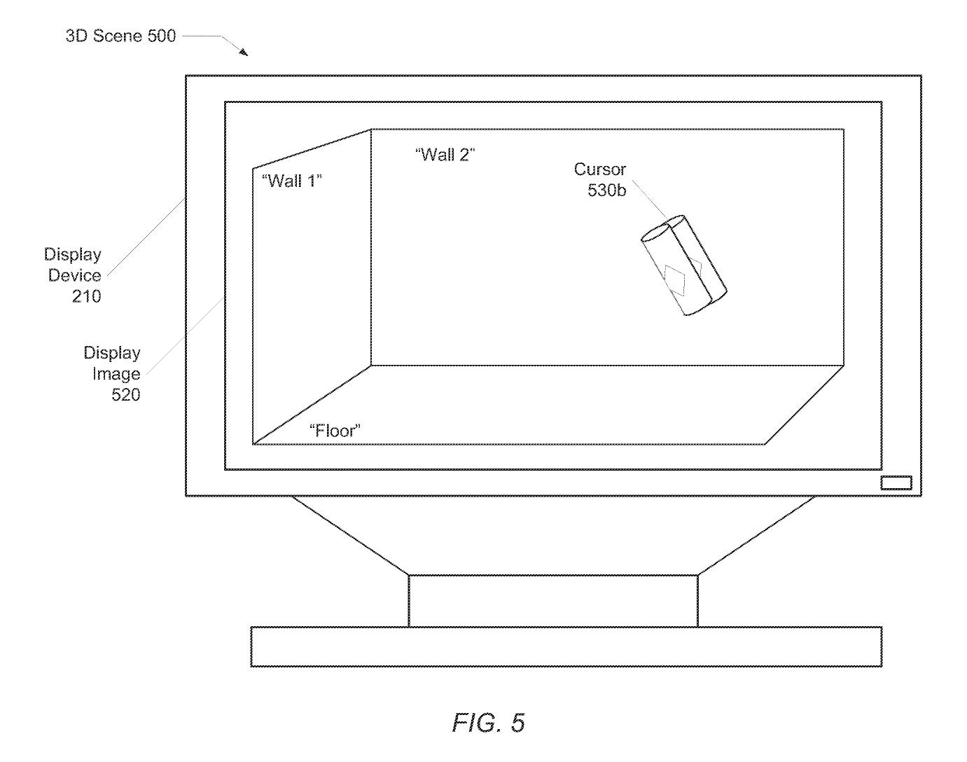

Referring now to FIG. 5, a generalized block diagram illustrating another embodiment of a three-dimensional (3D) scene 500 is shown. The display device 210 may include another simplified 3D scene as shown in display image 520. Again, only a cursor is shown and no other object. The cursor may include images 530a-530b placed at particular coordinates to provide a perception of depth. The cursor may use the same shape as the cursor shown in the display image 420. However, the pov of the user is different for display image 520 than the pov used for the display image 420. The pov of the user may be the same as the pov shown for display image 320 in FIG. 3. Here, the back wall is “Wall 2” with “Wall 1” positioned to the left. As the user changes the pov, more surface area of the cursor may be presented. For example, more of the diamond underneath the cursor may be shown.

Regardless whether the cursor includes sufficient shape data to present changing surface area as the user pov changes, the cursors in the above examples still include a perceived depth with the respective 3D scenes. As a user maneuvers a cursor around a 3D scene, the scene material being traveled over may not be affected. For example, the cursor may travel over and cover up another object or text that now occupies a same location as the cursor. When the cursor is moved again, the other object or text is shown unaffected.

The cursors may be implemented in software or hardware. Software cursors are generally managed by an operating system (OS). The software cursor is “redrawn” in video memory each time the software cursor moves to a new location. When the software cursor is moved, the information associated with the previously covered other object or text is refreshed. The continuous redrawing reduces performance. To avoid reducing performance while interacting with a 3D scene, the video graphics subsystem and its associated drivers may be updated to support a hardware cursor with perceived depth in a 3D scene.

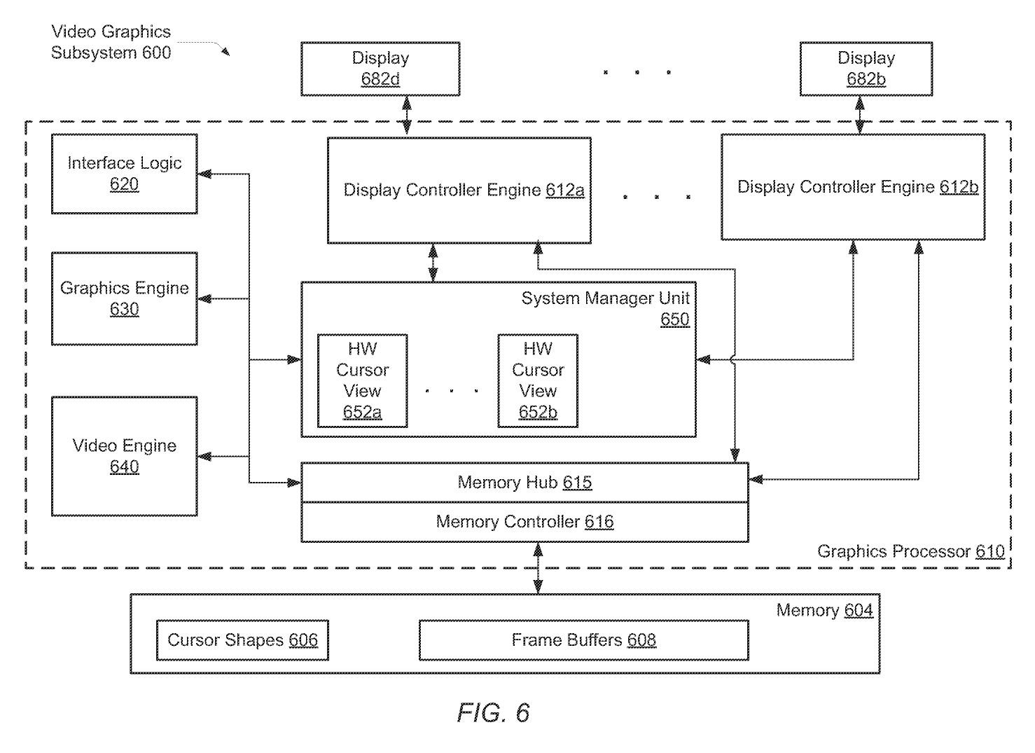

Turning now to FIG. 6, a generalized block diagram of one embodiment of a computing system 600 is shown. As shown, one or more displays 682a-682b are connected to a graphics processor 610. As used herein, a graphics processor may also be referred to as a graphics processing unit (GPU). Memory 604 is connected to the graphics processor 610. A system manager unit (SMU) 650 may be included which is configured to coordinate operations and communications among the multiple components within the graphics processor 610. The SMU 650 may include multiple hardware blocks 652a-652b, each used to update a separate, slightly different, hardware cursor view. For example, a given hardware cursor shape may have an associated 3D sampled model generated from a 3D scanning technique. The hardware cursor may have multiple associated shapes that are selected by an executing software application.

In one embodiment, an operating system (OS) receives updated coordinates for the given hardware (HW) cursor shape based on indications received from a user's input peripheral device. The coordinates may include an x-, y- and z-axis relative distances. This information may be provided to an executing software application using 3D scenes. The software application may utilize one or more algorithms to generate a set of coordinates and a disparity value for each one of multiple images used to present a 3D image of the cursor.

The updated information from the software application may include the coordinates and disparity values corresponding to each one of multiple views used to present a perception of depth for a displayed image of the cursor. In addition, the update information may include an indication of a shape to use for the cursor. Further, the update information may include different angle or view of the cursor shape. This indication may include a different memory location address to use for the cursor shape in order to present a different surface area of the cursor. Although the shape of the cursor is a same arrow, pencil, pointer, or other shape, the different view of it may be treated as a different shape with a different memory address. The HW blocks 652a-652b may receive the updated information sent from the software application.

The HW blocks 652a-652b may determine a respective height and width for a corresponding view of the cursor. The disparity value may be used for this determination. Afterward, the memory address for the associated cursor shape may be used to access the shape data stored in the memory locations indicated by the cursor shape data 606 within the memory 604. A respective view of the 3D cursor may be built from the height and width information, the received coordinates, and the accessed shape data. The respective view may be sent to a corresponding one of the display controller engines (DCEs) 612a-612b with the other built images. Offloading the work of building the cursor from the OS to the computing system 600 reduces a workload for both the OS and an associated general-purpose central processing unit (CPU), or processor. The hardware generation of the cursor may also be referred to as hardware acceleration.

Similar to the software cursor, the 3D hardware (HW) cursor is an overlay—meaning that the HW cursor both is separate from the other graphical information in the 3D scene and the HW cursor has video priority. Overlay video graphics information generally has higher priority over other video graphics information when both are being prepared for display. For example, if it is determined the HW cursor overlaps a portion or all of another graphical object, then the HW cursor is presented and covers up the overlapping graphical information. Further, the data associated with the HW cursor shape is stored separately from the data associated with the remainder of the 3D scene. The HW cursor shape data is stored in the cursor shape memory locations 606. The remainder of the 3D scene is stored in the frame buffer 608 within the memory 604. Therefore, no redrawing or refreshing is performed when the HW cursor moves to a new location. Before describing further details of the HW blocks 652a-652b and associated drivers and libraries, a further description of the other components of the computing system 600 is provided below.

Each of the displays 682a-682b connected to the graphics processor 610 may have a respective frame buffer in the memory 604. Such a frame buffer may store data, such as video frames, for a corresponding one of the displays 682a-682b. The memory 604 may utilize a multi-channel memory architecture. Each of the memory channels may be a separate interface to a memory. This type of architecture may increase the transfer speed of data. The separate channels allow each memory module access to the memory controller 616 and the memory hub 615, which increases throughput bandwidth. In one embodiment, each of the memory modules may each have a same protocol for a respective interface to the memory controller 616. One example of a protocol is a double data rate (DDR) type of protocol. The protocol may determine values used for information transfer, such as a number of data transfers per clock cycle, signal voltage levels, signal timings, signal and clock phases and clock frequencies. Protocol examples include DDR2 SDRAM, DDR3 SDRAM, GDDR4 (Graphics Double Data Rate, version 4) SDRAM, and GDDR5 (Graphics Double Data Rate, version 5) SDRAM. Access to the data stored in the frame buffer may occur through one or more of these memory channels.

The graphics processor 610 includes one or more display controller engines (DCEs) 612a-612b for sending graphics output information to the displays 682a-682b. For example, when outputting information to a display device, the DECs may merge data corresponding to a 3D scene stored in frame buffers 608 and cursor data. In addition, the graphics processor 610 includes interface logic 620, a memory hub 615 and a memory controller 616 for supporting access to outside devices and memory. The memory hub 615 may include switching logic to connect a given one of the DCEs 612a-612b to the memory controller 616. The memory controller 616 may include logic for supporting a given protocol used to interface to the memory channels used in the memory architecture. In various embodiments, the hub 615 and circuitry within the memory controller 616 may be combined or implemented separately as desired. All such embodiments are contemplated. The graphics engine 630 and the video engine 640 may perform data-centric operations for at least graphics rendering and 3D graphics applications.

A video controller and a video connector and/or adapter may be connected between each of the display controller engines (DCEs) 612a-612b and a respective one or more of the displays 682a-682b. Each of the display controller engines (DCEs) 612a-612b may include circuitry for sending rendered graphics output information from the graphics memory, such as the frame buffers 608. Alternatively, each of the DCEs 612a-612b may send graphics output information from the graphics engine 630 and/or the video engine 640 producing raster-based data results. The frame buffers are typically accessed via a memory mapping to the memory space of the graphics processor 610. The memory mappings may be stored and updated in the DCEs 612a-612c. The information stored in the frame buffers may include at least color values for pixels. When frame buffers 608 are updated, the SMU 650 may be instructed to point to new frame buffer data. Accordingly, the addresses stored in the DCEs 612a-612b may be updated to point to the new memory locations corresponding to the new frame buffers.

The interface logic 620 may communicate with other semiconductor chip designs, processing nodes, buses and input/output (I/O) devices. The interface logic 620 may follow an interface protocol that determines a bus standard, error detecting and reporting mechanisms, and signal timings. Generally, the interface logic 620 may include buffers for sending and receiving packets, data and messages. The interface logic 620 may receive a rendering command stream, state information, and geometry data for floating point operations from a general-purpose processor core or other controller. In some embodiments, rather than providing this information directly, a processor core may provide references to locations in memory at which this information is stored. Accordingly, the graphics processor 610 retrieves the information from the specified locations.

The rendering command stream, state information, and geometry data may be used to define the desired rendered image or images, including geometry, lighting, shading, texture, motion, and/or camera parameters for a scene. In one embodiment, the geometry data includes a number of definitions for objects (e.g., a table, a tree, a person or animal) that may be present in the scene. Groups of primitives (e.g., points, lines, triangles and/or other polygons) may be used to model objects. The primitives may be defined by a reference to their vertices. For each vertex, a position may be specified in an object coordinate system, representing the position of the vertex relative to the object being modeled.

In addition to a position, each vertex may have various other attributes associated with it. Examples of other vertex attributes may include scalar or vector attributes used to determine qualities such as the color, texture, transparency, lighting, shading, and animation of the vertex and its associated geometric primitives. The graphics engine 630 may include one or more texture units for executing pixel shader programs for visual effects. The graphics engine 630 may include additional units for accelerating geometric calculations such as the rotation and translation of vertices into different coordinate systems.

The graphics engine 630 may additionally include multiple parallel data paths. Each of the multiple data paths may include multiple pipeline stages, wherein each stage has multiple arithmetic logic unit (ALU) components and operates on a single instruction for multiple data values in a data stream. The graphics engine 630 may generally execute the same programs, such as vertex shaders or pixel shaders, on large numbers of objects (vertices or pixels). Since each object is processed independently of other objects, but the same sequence of operations is used, a SIMD parallel datapath may provide a considerable performance enhancement. The graphics engine 630 may perform these and other calculations for 3D computer graphics. The video engine 640 may provide a video decoding unit to allow video decoding to be hardware accelerated. In one embodiment, the video engine 640 performs at least frequency transformations, pixel prediction and inloop deblocking, but may send the post-processing steps to the shaders in the graphics engine 630.

Once processing for a pixel or group of pixels is complete, these pixel values may be integrated with pixels of an image under construction. In some embodiments, the new pixel values may be masked or blended with pixels previously written to the rendered image. Afterward, the processed data may be sent to the DRAM for storage via both the memory hub 615 and the memory controller 616. At a later time, a given one of the DCEs 612a-612b reads corresponding data stored in the DRAM and sends it to a corresponding one of the displays 682a-682b.

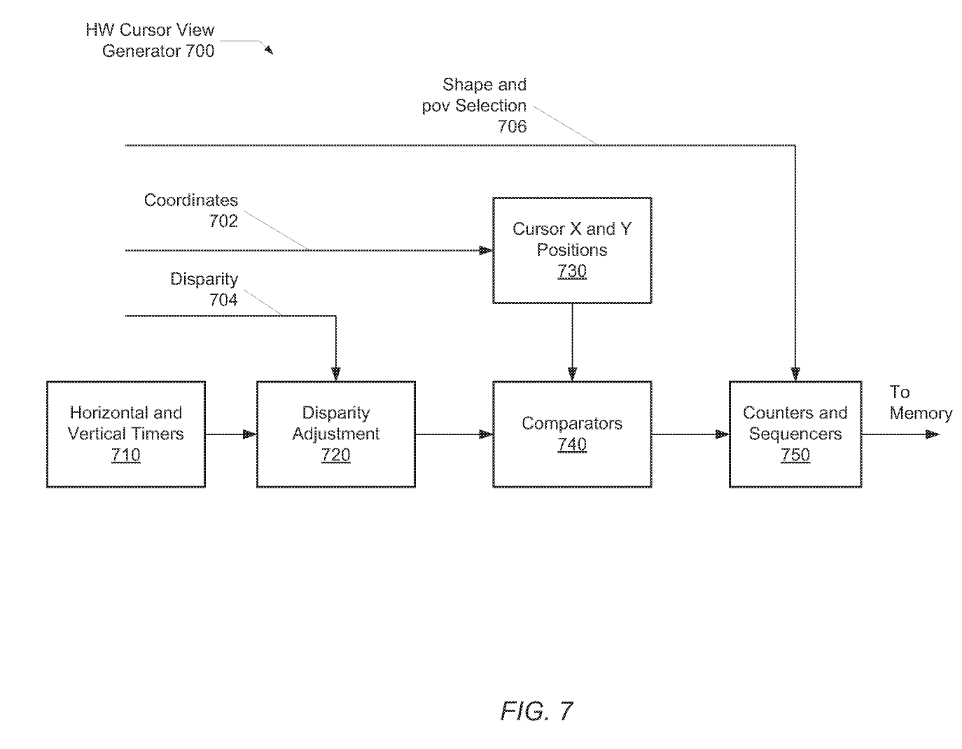

Turning now to FIG. 7, a generalized block diagram of one embodiment of a HW cursor view generator 700 is shown. The circuitry within the blocks 710-750 may be used to generate a given view of a hardware cursor. When the generated views from each of the HW blocks 652a-652b in the graphics processor 610 are grouped together on a display device, the user's vision may render the generated images as a 3D image of a cursor with a perception of depth.

The horizontal and vertical timers 710 maintain the pixel pulse counts in the horizontal and vertical dimensions of a corresponding display device. A vertical timer may maintain a line count and provide a current line count to comparators in the block 740. The vertical time may also send an indication when an end-of-line (EOL) is reached. The registers in the block 730 receive the updated coordinates 702 from the software application through the OS. The coordinates may refer to horizontal and vertical coordinates of a computed position of a given view of the cursor. The cursor itself may appear in a different position when the views are combined by the user's vision. The current pixel pulse values are compared to the associated horizontal or vertical coordinate values with the comparators in block 730. In one embodiment, the received disparity value 704 is used to adjust the pixel pulse values in block 720. Alternatively, an adjustment may be made later in the generation chain of blocks. The adjustment may cause an image to shrink or grow from a default size based on a computed perception of depth for the associated view of the cursor image. Matches found during the comparisons cause associated counters to being counting in block 750. In some embodiments, a MIPMAP type texture may be used for a cursor in which case scaling of an image may not be necessary.

Horizontal and vertical counters may be configurable to values associated with targeted width and height values. The disparity value 704 may be used in this stage to adjust the width and height of the associated view of the cursor image. When pixel pulse values surpass a given threshold and the comparisons produce mismatches, the counters may stop counting.

Sequencers within the block 750 may generate addresses of memory locations 606 to access in memory 604. The shape selection data 706 may be used to determine a beginning memory location for cursor shape data. In some embodiments, the accessed cursor shape data may be sent to one or more of the engines 630-64 for rendering. In other embodiments, the accessed cursor shape data may be sent to a corresponding one of the DCEs 612a-612b. In yet other embodiments, the generator 700 may receive the accessed cursor shape data and arrange the data in a formatted order prior to sending it to one of the DCEs 612a-612b. In some

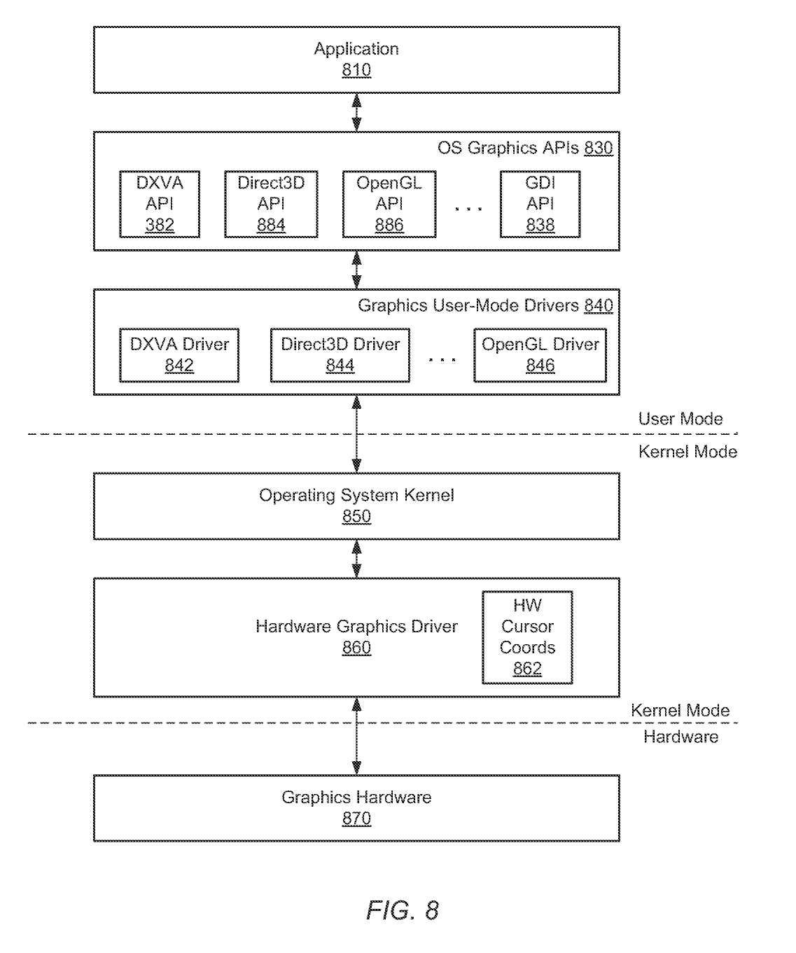

Turning now to FIG. 8, a generalized block diagram illustrating one embodiment of a video graphics driver layering model 800 is shown. As shown, the video graphics driver layering model 800 includes user-mode components and kernel-mode components. In one embodiment, graphics software drivers corresponding to the graphics hardware 870 may include both user-mode components and kernel-mode components. Such a configuration may separate much of the activities of the graphics driver 860 from the operating system and other applications. In addition, some functionalities of the hardware graphics driver 860 may be distributed across drives in the graphics user-mode drivers 840.

In one embodiment, the graphics user-mode drivers 840 are isolated from the OS kernel 850, the kernel-mode graphics driver 860, and the graphics hardware 870. The OS may load a separate copy of the user-mode drivers 840 for each application 810. A graphics hardware vendor may supply the user-mode graphics drivers 840 and the hardware graphics driver 860. The user-mode graphics drivers 840 may each be a dynamic-link library (DLL) that is loaded by corresponding APIs in the OS graphics APIs 830. Alternatively, runtime code may be used to install the user-mode graphics drivers 840.

In various embodiments, corresponding graphics libraries and drivers may be configured to pass cursor coordinate information from the software application 810 to the computing system 600 represented here as graphics hardware 870. In one embodiment, one or more of the graphics APIs and the user-mode graphics drivers 840 may be built with a software development kit (SDK) associated with a corresponding operating system. Therefore, the user-mode graphics drivers 840 may be extensions to SDKs supported by the operating system. In one example, the user-mode graphics drivers 840 may be extensions to the Direct3D and OpenGL SDKs. Accordingly, the passing of information associated with 3D HW cursors may be made available through a standard interface. In particular, the OpenGL API 886 and the OpenGL driver 846 may be updated with one or more functions to perform the information passing. In addition, the hardware graphics driver 860 may be updated with functionality, such as the block 862 used for handling the cursor coordinate information being passed down. Alternatively, one or more existing functions may be used to pass 3D HW cursor update information down the layers to hardware. In another example, a driver escape code or sequence supported by the graphics APIs 830 may be used to indicate to the driver that a given portion of a statement is to be handled differently. When a corresponding one of the user-mode graphics drivers 840 processes the escaped portion of a string, the driver may translate the portion of the string in order for one or more of the application 810 and the hardware graphics driver 860 to correctly process received information.

The hardware graphics driver 860 communicates with each of the OS kernel 850 and the graphics hardware 870. The OS kernel 850 may include at least a video memory manager and a GPU scheduler. In addition, in response to receiving an indication from an input pointer device that the user updated the location of the 3D HW cursor, the OS kernel 850 may send the information to the software application 810 to utilize one or more algorithms to modify or generate the associated coordinate information to pass to the graphics hardware 870. The graphics APIs 830 includes functions that may be called by the graphics drivers 840 to connect to and configure displays.

A software application 810 may be executing code for a 3D scene for a gaming, business, medical, CAD design, or other end-user application. Based on selections and interactions from the user through the 3D HW cursor, the application 810 may adjust its execution path based on the user's decisions. The application 810 may operate on graphical information for the 3D scene and corresponding objects, but not for the 3D HW cursor. Rather, the video graphics hardware 870 operates on data associated with the 3D HW cursor and its associated shapes.

One or more APIs within the OS APIs 830 may be used for one or more of the user-mode drivers 840. An OS kernel 850 may receive queries from the OS graphics APIs 830 and the graphics user-mode drivers 840. The OS kernel 850 may pass on queries and other packets and/or messages to the hardware graphics driver 860 according to given protocols. The software application 810 may also send command streams and data while executing code. The command streams may be executed by a GPU within the graphics hardware 870 using the received data.

In the model 800, each user-mode and kernel-mode driver may be responsible for processing a part of a request from the application 810. If a given driver cannot complete the request, information for a driver in a lower layer may be set up and the request is passed along to that driver. The model 800 may allow each driver to specialize in a particular type of function and decouples it from having to know about other drivers. Drivers at a higher layer in the model 800 may add modifications and enhancements to the processing of graphics requests from the application 810 without re-writing underlying drivers.

In one embodiment, the user-mode graphics drivers 840 include a driver 842 that allows video decoding to be hardware accelerated. Certain CPU-intensive operations such as motion compensation and deinterlacing may be offloaded to a GPU. In one embodiment, this driver 842 is a DirectX Video Acceleration (DXVA) driver. In this embodiment, the DXVA driver 842 may follow an API specification from Microsoft Corp. This specification may include the DXVA API 382 within the user-mode graphics APIs 830. In one embodiment, Microsoft Vista® may be used as the OS. In other embodiments, Linux® and other types of OSes and corresponding drivers and APIs may be used.

In one embodiment, the user-mode graphics drivers 840 include a driver 844 that performs rendering of three-dimensional (3D) graphics in applications. The driver 844 may identify operations to be performed on the graphics hardware 870, such as at least anti-aliasing, alpha blending, atmospheric effects, and perspective-correct texture mapping. The driver 844 may use hardware acceleration available on the graphics hardware 870. In one embodiment, this driver 844 is a Direct3D graphics driver. In this embodiment, the Direct3D driver 824 may follow an API specification from Microsoft Corp. This specification may include the Direct3D API 884 within the user-mode graphics APIs 530.

In one embodiment, the graphics user-mode drivers 840 include the OpenGL driver 846. In this embodiment, the OpenGL driver 846 may follow an API specification from Microsoft Corp. This specification may include the OpenGL API 886 within the user-mode graphics APIs 830. The OpenGL API 886 is a standard API specification defining a cross-language, cross-platform API for writing applications that produce 2D and 3D computer graphics. The Direct3D API 884 and the OpenGL API 886 are competing APIs, which can be used by the application 810 to render 2D and 3D computer graphics. The APIs 884 and 886 may take advantage of hardware acceleration when available. Modern GPUs may implement a particular version of one or both of the APIs 884 and 886. The Direct3D API 884 generally targets the Microsoft Windows platform. The OpenGL API 886 generally is available for multiple platforms, since the API 886 utilizes an open source license.

In one embodiment, the OS APIs 830 includes the GDI API 838. In this embodiment, the GDI API 838 may follow an API specification from Microsoft Corp. The GDI API 838 represents graphical objects and transmits them to output devices such as monitors and printers. The GDI API 838 may be used to perform tasks such as drawing lines and curves, rendering fonts and handling palettes.

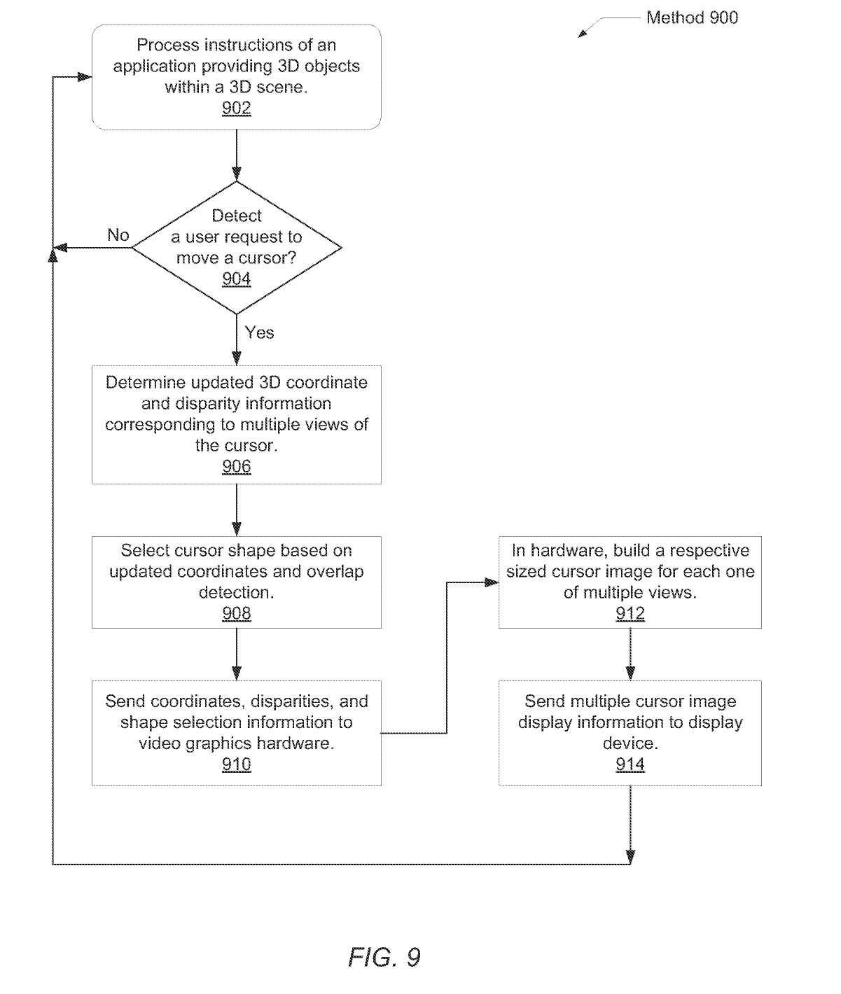

Referring now to FIG. 9, one embodiment of a method 900 for using hardware to update a three-dimensional (3D) cursor in a 3D scene is shown. The components embodied in the video graphics subsystem and video graphics layering model described above may generally operate in accordance with method 900. For purposes of discussion, the steps in this embodiment are shown in sequential order. However, some steps may occur in a different order than shown, some steps may be performed concurrently, some steps may be combined with other steps, and some steps may be absent in another embodiment.

In block 902, program instructions for a three-dimensional (3D) application are loaded from memory into a processor and executed. When executed, the program instructions provide 3D objects within a 3D scene. If a user request from an input pointer device is detected, wherein the device indicates the user wishes to direct the cursor to a new location (conditional block 904), then in block 906, the OS sends an indication of the update to the software application. The software application uses one or more algorithms to produce at least updated 3D coordinate information and disparity values corresponding to multiple views of the cursor.

In block 908, the application may determine a cursor shape to use for the update. In addition, the shape selection may include a pov change that provides different surface area of the cursor to be shown. In block 910, the updated information is sent from the application to the video graphics hardware. The multiple views of the cursor may include at least two views sufficiently close to one another to create a stereoscopic effect when rendered.

In block 912, the hardware in the video graphics subsystem builds multiple views of the cursor image, wherein each view is appropriately sized. In block 914, the multiple views corresponding to the cursor image are sent to a corresponding display device.

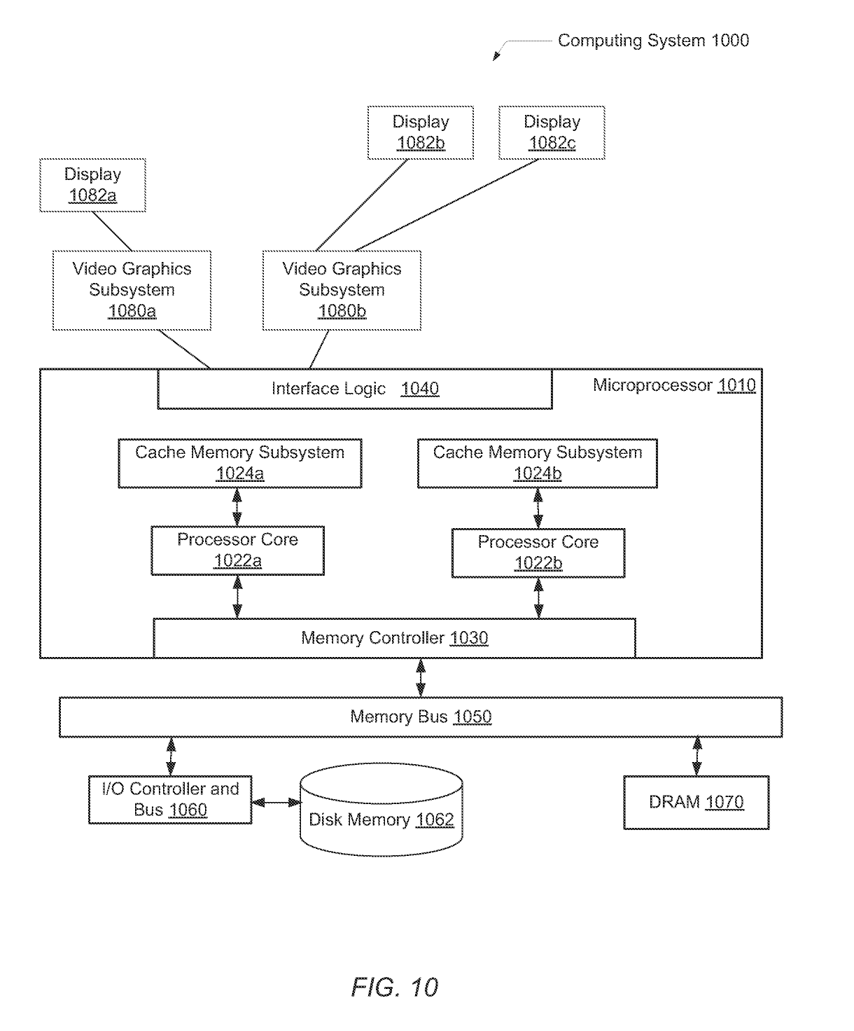

Referring to FIG. 10, a generalized block diagram of one embodiment of a computing system 1000 is shown. As shown, microprocessor 1010 may be connected to one or more video graphics subsystems 1080a-1080c. In one embodiment, one or more of the video graphics subsystems 1080a-1080b includes the circuitry and logic shown for computing system 600 in FIG. 6. One or more of the video graphics subsystems 1080a-1080b may be a video graphics card in a slot on a motherboard, which includes the microprocessor 1010. In other embodiments, one or more of the of the video graphics subsystems 1080a-1080c is a separate chip on a system-on-a-chip (SOC), which includes the microprocessor 1010.

In one embodiment, a GPU supports one to two display outputs simultaneously and independently. For example, the video graphics subsystem 1080a may include a GPU that supports, or is currently configured to support, a single display, such as display 1082a. The video graphics subsystem 1080b may include a GPU that supports two displays, such as displays 1082b-1082c. The computing system 1000 may support more than two displays by combining multiple GPUs on a single graphics card. Alternatively, the computing system 1000 may use two or more graphics cards.

One or more of the displays 1082a-1082c may be used to present a 3D scene to users. Each of the displays 1082a-1082g may include modern TV or computer monitors that include a thin film transistor liquid crystal display (TFT-LCD) panel. Additionally, the displays 1082a-1082g may include monitors for laptops and other mobile devices. Alternatively, one or more of the display devices 1082a-1082g may include monitors with an organic light-emitting diode (OLED) or other suitable technology.

The microprocessor 1010 may include one or more processor cores 1022a-1022b connected to corresponding one or more cache memory subsystems 1024a-1024b. The microprocessor may also include interface logic 1040, and a memory controller 1030. Other logic and inter- and intra-block communication is not shown for ease of illustration. In one embodiment, the illustrated functionality of the microprocessor 1010 is incorporated upon a single integrated circuit. In another embodiment, the illustrated functionality is incorporated in a chipset on a computer motherboard. In one embodiment, the microprocessor 1010 is a stand-alone system within a mobile computer, a smart phone, or a tablet; a desktop; a server; and the like.

Each of the processor cores 1022a-1022b may include circuitry for executing instructions according to a given instruction set. For example, the x86 instruction set architecture (ISA) may be selected. Alternatively, the Alpha, PowerPC, or any other instruction set architecture may be selected. In one embodiment, each of the processor cores 1022a-1022b may include a superscalar, multi-threaded microarchitecture used for processing instructions of a given ISA.

Each of the cache memory subsystems 1024a-1024b may reduce memory latencies for a respective one of the processor cores 1022a-1022b. In addition, one or more shared cache memory subsystems may be used. The cache memory subsystems 1024a-1024b may include high-speed cache memories configured to store blocks of data. Each of the cache memory subsystems 1024a-1024b and 1028 may include a cache memory, or cache array, connected to a corresponding cache controller.

The memory controller 1030 may translate addresses corresponding to requests sent to the off-chip DRAM 1070 through the memory bus 1050. The memory controller 1030 may include control circuitry for interfacing to the memory channels and following a corresponding protocol. Additionally, the memory controller 1030 may include request queues for queuing memory requests. The off-chip DRAM 1070 may be filled with data from the off-chip disk memory 1062 through the I/O controller and bus 1060 and the memory bus 1050. In one embodiment, the off-chip disk memory 1062 may include one or more hard disk drives (HDDs). In another embodiment, the off-chip disk memory 1062 utilizes a Solid-State Disk (SSD).

In one embodiment, each of the memory modules may each have a same protocol for a respective interface to the memory controller 1030. One example of a protocol is a double data rate (DDR) type of protocol. The protocol may determine values used for information transfer, such as a number of data transfers per clock cycle, signal voltage levels, signal timings, signal and clock phases and clock frequencies. Protocol examples include DDR2 SDRAM, DDR3 SDRAM, GDDR4 (Graphics Double Data Rate, version 4) SDRAM, and GDDR10 (Graphics Double Data Rate, version 10) SDRAM. The storage technology and protocols described above for the DRAM 1070 may apply for the DRAM within one or more of the video graphics subsystems 1080a-1080c.

It is noted that the above-described embodiments may comprise software. In such an embodiment, the program instructions that implement the methods and/or mechanisms may be conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Additionally, program instructions may comprise behavioral-level description or register-transfer level (RTL) descriptions of the hardware functionality in a high level programming language such as C, or a design language (HDL) such as Verilog, VHDL, or database format such as GDS II stream format (GDSII). In some cases the description may be read by a synthesis tool, which may synthesize the description to produce a netlist comprising a list of gates from a synthesis library. The netlist comprises a set of gates, which also represent the functionality of the hardware comprising the system. The netlist may then be placed and routed to produce a data set describing geometric shapes to be applied to masks. The masks may then be used in various semiconductor fabrication steps to produce a semiconductor circuit or circuits corresponding to the system. Alternatively, the instructions on the computer accessible storage medium may be the netlist (with or without the synthesis library) or the data set, as desired. Additionally, the instructions may be utilized for purposes of emulation by a hardware based type emulator from such vendors as Cadence®, EVE®, and Mentor Graphics®.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A graphics processor comprising:
one or more input buffers configured to store information corresponding to a plurality of views of a cursor in a three-dimensional (3D) space; and
circuitry configured to:
generate cursor data representing said cursor based at least in part on said plurality of images;
generate frame buffer data corresponding to a 3D scene; and
merge said frame buffer data and the cursor data for output to a display device.

2. The graphics processor as recited in claim 1, wherein the graphics processor further comprises output buffers configured to send the multiple images to a display engine with corresponding placement information describing a location on a display device.

3. The graphics processor as recited in claim 1, wherein the information comprises horizontal and vertical position data, and binocular disparity data.

4. The graphics processor as recited in claim 3, wherein at least two images of the plurality of images are configured to create a stereoscopic image when presented on a display device.

5. The graphics processor as recited in claim 4, wherein said cursor data is generated separately from the frame buffer data.

6. The graphics processor as recited in claim 4, wherein the information further comprises data which identifies a cursor shape.

7. The graphics processor as recited in claim 4, wherein said circuitry is configured to:
receive updated information regarding a position of the cursor in the 3D space; and
generate two or more new images of the cursor responsive to the updated information.

8. The graphics processor as recited in claim 3, wherein the circuitry is further configured to determine a height and a width for a plurality of images based on the information, wherein each one of the plurality of images corresponds to a respective one of the plurality of views of the cursor.

9. The graphics processor as recited in claim 1, further comprising a display in communication with said graphics processor and displaying the merged frame buffer data on said display.

10. A method comprising:
storing information corresponding to a plurality of views of a cursor in a three-dimensional (3D) space;
generating cursor data representing said cursor based at least in part on said plurality of images;
generating frame buffer data corresponding to a 3D scene; and
merging said frame buffer data and the cursor data when output to a display device.

11. The method as recited in claim 10, further comprising sending the multiple images to a display engine with corresponding placement information describing a location on display device.

12. The method as recited in claim 10, wherein the information comprises horizontal and vertical position data, and binocular disparity data.

13. The method as recited in claim 12, wherein at least two images of the plurality of images are configured to create a stereoscopic image when presented on a display device.

14. The method as recited in claim 13, wherein said cursor data is generated separately from the frame buffer data.

15. The method as recited in claim 13, wherein the information further comprises data which identifies a cursor shape.

16. The method as recited in claim 13, further comprising:
receiving updated information regarding a position of the cursor in the 3D space; and
generating two or more new images of the cursor responsive to the updated information.

17. The method as recited in claim 12, further comprising determining a height and a width for a plurality of images based on the information, wherein each one of the plurality of images corresponds to a respective one of the plurality of views of the cursor.

18. A video graphics subsystem comprising:
a processor; and
a memory configured to store data for one or more shapes associated with a cursor;
wherein the processor is configured to:
store information corresponding to a plurality of views of a cursor in a three-dimensional (3D) space;
generate cursor data representing said cursor based at least in part on said plurality of images;
generate frame buffer data corresponding to a 3D scene; and
merge said frame buffer data and the cursor data when output to a display device.

19. The video graphics subsystem as recited in claim 18, wherein the subsystem further comprises output buffers configured to send the multiple images to a display engine with corresponding placement information describing a location on the 3D display.

20. The video graphics subsystem as recited in claim 19, wherein the information comprises horizontal and vertical position data, and binocular disparity data.

21. The video graphics subsystem as recited in claim 20, wherein at least two images of the plurality of images are configured to create a stereoscopic image when presented on a display device.
